(19) United States
(12) Patent Application Publication
(10) Pub. No.: US 2023/0128363 A1
(43) Pub. Date: Apr. 27, 2023

(54) SYSTEMS AND METHODS FOR VIRTUALLY TRYING ON JEWELRY

(71) Applicant: Baracoda Daily Healthtech, Neuilly-sur-Seine (FR)

(72) Inventors: Thomas Serval, Neuilly-sur-Seine (FR); Olivier Giroud, Neuilly-sur-Seine (FR); Vincent El Kouby-Benichou, Neuilly-sur-Seine (FR)

(21) Appl. No.: 17/971,152

(22) Filed: Oct. 21, 2022

Related U.S. Application Data
(60) Provisional application No. 63/270,399, filed on Oct. 21, 2021.

(51) Int. Cl. G06Q 30/06; G06T 19/00; G06T 19/20; G06T 17/00; G06T 7/60; G06T 7/70

(52) U.S. Cl. CPC G06Q 30/0643; G06T 7/60; G06T 7/70; G06T 17/00; G06T 19/006; G06T 19/20; G06T 2207/30204; G06T 2219/2004

(57) ABSTRACT

A method of permitting an individual to virtually try on a piece of jewelry using augmented reality comprises generating image data associated with the individual and a trial implement. The trial implement is positioned about a portion of the individual. The image data can be generated using one or more image sensors. The method further comprises analyzing the image data to identify the trial implement. The method further comprises causing an electronic display device to display a real-time video of a virtual version of the individual and a virtual version of the piece of jewelry on the individual. The virtual version of the piece of jewelry is positioned relative to the virtual version of the individual based at least in part on the identified trial implement.

### TECHNICAL FIELD

The present disclosure relates generally to systems and methods virtually trying on jewelry, and more particularly, to systems and methods for using augmented reality to replacing a trial jewelry implement with a virtual version of a piece of jewelry.

### BACKGROUND

Before purchasing a piece of jewelry (such as a necklace), individuals often wish to physically try on the jewelry to examine the visual appearance of the jewelry. In some cases, however, the individual may not be able to physically try on the piece of jewelry. For example, the piece of jewelry may be a custom design that does not physically exist yet, or the piece of jewelry may be located in a different location from the individual. Thus, the individual is not able to examine the visual appearance of the piece of jewelry when worn, prior to the purchases. Thus, new systems and methods are needed that allow the individual to virtually try on the piece of jewelry without having access to the physical piece of jewelry.

### SUMMARY

According to some implementations of the present disclosure, a method of permitted an individual to virtually try on a piece of jewelry using augmented reality includes generating image data associated with the individual and a trial implement. The trial implement is positioned about a portion of the individual. The image data can be generated using one or more image sensors. The method further comprises analyzing the image data to identify the trial implement. The method further comprises causing an electronic display device to display a real-time video of a virtual version of the individual and a virtual version of the piece of jewelry on the individual. The virtual version of the piece of jewelry is positioned relative to the virtual version of the individual based at least in part on the identified trial implement.

According to some implementations of the present disclosure, a system for permitting an individual to virtually try on a piece of jewelry using augmented reality includes an image sensor, an electronic display device, a memory device, and a control system. The image sensor is configured to generate image data. The electronic display device is configured to display real-time videos. The memory device stores machine-readable instructions. The control system includes one or more processors that are configured to execute the machine-readable instructions to cause the image sensor to generate image data associated with the individual and a trial implement. The trial implement is positioned about a portion of the individual. The execution of the machine-readable instructions further causes the control system to analyze the image data to identify the trial implement. The execution of the machine-readable instructions further causes the electronic display device to display a real-time video of a virtual version of the individual and a virtual version of the piece of jewelry on the individual. The virtual version of the piece of jewelry is positioned relative to the virtual version of the individual based at least in part on the identified trial implement.

According to some implementations of the present disclosure, a trial jewelry implement for permitting an individual to virtually try on a piece of jewelry using augmented reality, the trial jewelry implement comprises a body and a plurality of fiducial markers. The body is configured to be positioned about a portion of the individual. Each of the plurality of fiducial markers is coupled to the body. Each of the plurality of fiducial markers is located a known distance along the body away from at least one adjacent fiducial marker of the plurality of fiducial markers.

The above summary is not intended to represent each implementation or every aspect of the present disclosure. Additional features and benefits of the present disclosure are apparent from the detailed description and figures set forth below.

### BRIEF DESCRIPTION OF THE DRAWINGS

FIG. 1 is a functional block diagram of a system, according to some implementations of the present disclosure;

FIG. 2A is a view of a trial implement, according to some implementations of the present disclosure;

FIG. 2B is a view of two trial implement portions, according to some implementations of the present disclosure;

FIG. 2C is a view of the two trial implement portions of FIG. 2B joined with another trial implement portion to form a trial implement with a non-standard configuration, according to some implementations of the present disclosure;

FIG. 3A is a view of an individual wearing the trial jewelry implement of FIGS. 2A 2B 2C in a first position, according to some implementations of the present disclosure;

FIG. 3B is a view of an electronic displaying showing a virtual version of the individual and a virtual version of a piece of jewelry in the first position, according to some implementations of the present disclosure;

FIG. 4A is a view of the individual wearing the trial jewelry implement of FIGS. 2A 2B 2C in a second position, according to some implementations of the present disclosure;

FIG. 4B is a view of the electronic displaying showing the virtual version of the individual and the virtual version of a piece of jewelry in the second position, according to some implementations of the present disclosure; and

FIG. 5 is a flowchart of a method of permitting an individual to virtually try on a piece of jewelry using augmented reality, according to some implementations of the present disclosure.

While the present disclosure is susceptible to various modifications and alternative forms, specific implementations and embodiments thereof have been shown by way of example in the drawings and will herein be described in detail. It should be understood, however, that it is not intended to limit the present disclosure to the particular forms disclosed, but on the contrary, the present disclosure is to cover all modifications, equivalents, and alternatives falling within the spirit and scope of the present disclosure as defined by the appended claims.

### DETAILED DESCRIPTION

Disclosed herein are systems and methods for allowing an individual to virtually try on a desired piece of jewelry using augmented reality. The individual can wear a trial jewelry implement that can have the same or a similar shape as the piece of jewelry. An electronic display device can then show images or videos of the individual, where the trial jewelry implement in the images or videos is replaced with the piece of jewelry.

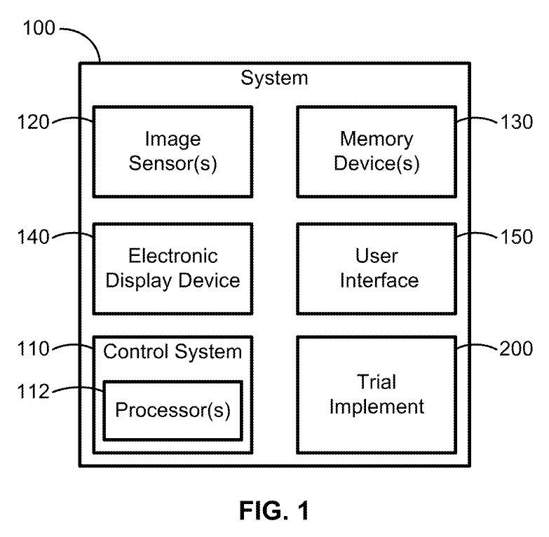

Referring now to FIG. 1, system 100 can be used to display a virtual version of the individual and a virtual version of the desired piece of jewelry. System 100 includes a control system 110, one or more image sensors 120 (hereinafter, image sensor 120), one or more memory devices 130 (hereinafter, memory device 130), an electronic display device 140, and a trial jewelry implement 200 (referred to herein as the trial implement 200). The control system 110 includes one or more or more processors 112 (hereinafter, processor 112). The control system 110 is configured to control various components of the system 100. The processor 112 can be a general or special purpose processor or microprocessor. While one processor 112 is shown in FIG. 1, the control system 110 can include any suitable number of processors (e.g., one processor, two processors, five processors, ten processors, etc.) that can be in a single housing, or located remotely from each other. The control system 110 (or any other control system) or a portion of the control system 110 such as the processor 112 (or any other processor(s) or portion(s) of any other control system), can be used to carry out one or more steps of any of the methods described and/or claimed herein. The control system 110 can be centralized (within one such housing) or decentralized (within two or more of such housings, which are physically distinct). In such implementations including two or more housings containing the control system 110, such housings can be located proximately and/or remotely from each other. In some implementations, the control system 110 is part of a mobile device, such as a smart phone, a tablet computer, or a laptop computer.

The image sensor 120 generates image data that is reproducible as one or more images (e.g., still images, videos, thermal images, etc.) that can be stored in the memory device 130. The image data output by the image sensor 120 is associated with any object that is within the field of view of the image sensor 120, such as an individual and/or the trial implement 200. The control system 100 can be used to control the image sensor 120. For example, the control system 110 can activate the image sensor 120 to begin generating image data, deactivate the image sensor 120 to stop generating image data, modify one or more settings of the image sensor 120 to modify the generated image data, or any number of other functions. The image sensor 120 may include any number of different cameras, such as high-resolution cameras, thermal cameras, etc. In some implementations, the image sensor 120 is part of a mobile device, such as a smart phone, a tablet computer, or a laptop computer.

The memory device 130 stores the image data generated by the image sensor 120, and also stores machine-readable instructions that are executable by the processor 112 of the control system 110. The memory device 130 can be any suitable computer readable storage device or media, such as, for example, a random or serial access memory device, a hard drive, a solid state drive, a flash memory device, etc. While one memory device 130 is shown in FIG. 1, the system 100 can include any suitable number of memory devices 130 (e.g., one memory device, two memory devices, five memory devices, ten memory devices, etc.). Like the control system 110, the memory device 130 can be centralized (within one such housing) or decentralized (within two or more of such housings, which are physically distinct). The memory device 130 can be coupled to and/or positioned within the same housing or housings as the control system 110. In some implementations, the memory device 130 is part of a mobile device, such as a smart phone, a tablet computer, or a laptop computer.

The electronic display device 140 is configured to display images and/or videos based on the image data generated by the image sensor 120. Similar to the image sensor 120, the control system 110 can be used to control the electronic display device 140. For example, the control system 110 can turn the electronic display device 140 on and off, modify the images and/or the videos being shown on the electronic display device 140, and perform other functions related to the electronic display device 140. The electronic display device can be an LED display, an OLED display, an LCD display, or the like. In some implementations, the electronic display device 140 is part of a mobile device, such as a smart phone, a tablet computer, or a laptop computer; or a separate monitor coupled to a desktop computer.

In some implementations, the system 100 includes a user interface 150 that is configured to sense inputs made by an individual interacting with the system 100. The user interface 150 can include a mouse, a keyboard, one or more buttons, a touchscreen, a touch-sensitive substrate, etc. In some implementations, the user interface 150 is a touchscreen formed by all or part of the electronic display device 140. In some implementations, the input interface 150 is part of the same mobile device as the electronic display device 140.

The system 100 further includes the dummy piece of jewelry, referred to herein as the trial implement 200 (or a trial jewelry implement). During use of the system 100, the individual can wear the trial implement and position themselves in front of the image sensor 120. The image sensor 120 generates image data associated with the individual wearing the trial implement 200. The control system 110 can use the image data to display still a real-time video (and/or images or video clips) of the individual on the electronic display device 140. The real-time video shown on the electronic display device 140 will include a virtual version of the individual, and a virtual version of the desired piece of jewelry (sometimes referred to as a virtual implement). Generally, the position of virtual version of the piece of jewelry relative to the virtual version of the individual (in the real-time video) will be based on the3 physical position of the trial implement relative to the actual individual.

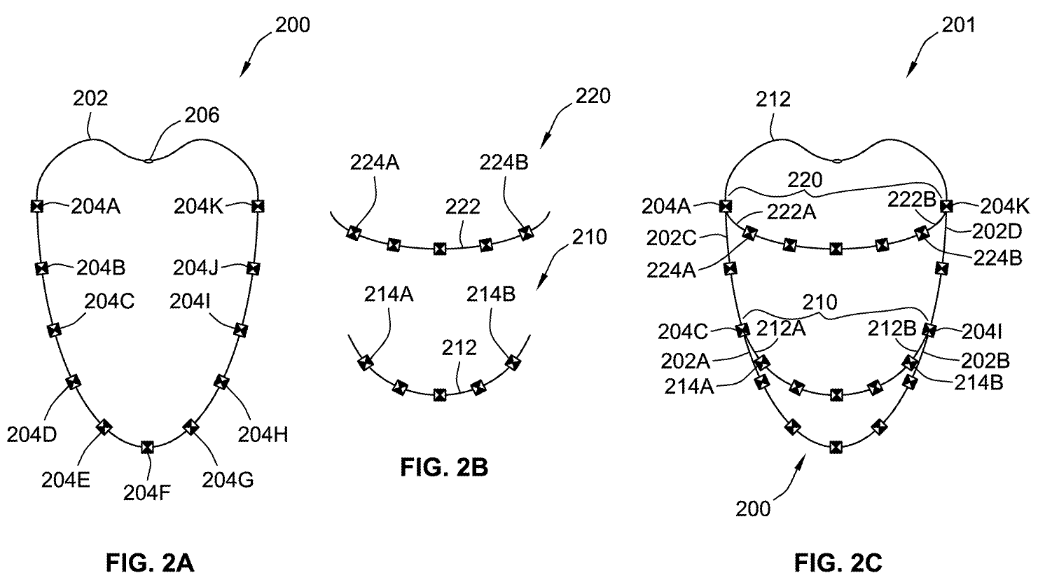

FIG. 2A illustrates the trial implement 200. The trial implement 200 is formed from a body 202 and a plurality of fiducial markers 204A-204K. The body 202 is generally formed from a flexible and bendable material that can conform to the shape of the individual (e.g., the shape of the individual’s neck, shoulders, and upper torso) when worn. For example, the body 202 can be formed from string, twine, rope, flexible polymers, wire rope, etc. The body 202 could also be formed from individual metal portions linked together (e.g., a metal chain), such that the body 202 conforms to the shape of the individual. In the illustrated implementation, the body 202 of the trial implement 200 is generally shaped like a necklace, and can be worn on the neck of the individual. However, the body 202 of the trial implement could also be shaped like a bracelet or a watch, and be worn on the wrist of the individual. In any of these implementations, the fiducial markers 204A-204K can generally form an outline of the desired piece of jewelry (e.g., a necklace, a bracelet, etc.). In implementations where the body 202 is shaped like a watch, the fiducial markers 204A-204K may additionally or alternatively form the outline of a watch face.

The fiducial markers 204A-204K provide a point of reference for the control system 110 when the image data generated by the image sensor 120. The control system 110 is able to identify the fiducial markers 204A-204K, so that the position of the trial implement 200 relative to the individual can be determined. In some implementations, each of the plurality of fiducial markers 204A-204K is located a known distance away from an adjacent one of the plurality of fiducial markers 204A-204K along the body 202. For example, the portion of the body 202 between fiducial markers 204E and 204F could be 6 inches, and the portion of the body 202 between fiducial markers 204F and 204G could also be 6 inches. Other dimensions can be used as well.

The fiducial markers 204A-204K can be formed from generally any suitable material, such as plastic, metal, foam, rubber, etc. In some implementations, the body 202 is formed from an optically non-reflective material, and each of the fiducial markers 204A-204K is formed from an optically reflective material. These materials can aid the control system in identifying the fiducial markers 204A-204K from the image data (e.g., by identifying reflections from the fiducial markers 204A-204K), and in identifying the body 202 (e.g., by identifying the space between the fiducial markers 204A-204K where little or no reflection occurs).

In the illustrated implementation, each of the fiducial markers 204A-204K has a generally square shape, with four different triangular indicators on the front face. However, the fiducial markers 204A-204K can generally have any desired shape or configuration. In some implementations, the fiducial markers 204A-204K can have a generally two-dimensional (2D) shape, such as a circular shape, a square shape, a rectangular shape, a triangular shape, a 2D cross shape, etc. In these implementations, each of the fiducial markers 204A-204K will have some thickness in a third dimensions, but this thickness is relatively insignificant compared to the size of the fiducial markers 204A-204K in the other two dimensions. In other implementations, the fiducial markers 204A-204K can have a generally three-dimensional (3D) shape, such as a spherical shape, cube shape, a cuboid shape, a cylindrical shape, a triangular pyramid shape, a square pyramid shape, a triangular prism shape, a 3D cross shape, etc.

In some implementations, the fiducial markers 204A-204K may include different indicators that can aid in identifying the fiducial markers 204A-204K. For example, the fiducial markers 204A-204K could include letters, numbers, or symbols that are printed or otherwise formed on a portion of the fiducial markers 204A-204K. In some implementations, each of the fiducial markers 204A-204K has a different indicator, to aid the control system 110 in distinguishing between different fiducial markers 204A-204K. For example, each of the fiducial markers 204A-204K could have a different letter, a different number, a different symbol, combinations thereof, etc. In other implementations, all of the fiducial markers 204A-204K have the same indicator.

In some implementations, the fiducial markers 204A-204K are designed so that the control system 110 can distinguish between different orientations of each of the fiducial markers 204A-204K. For example, the shape of the fiducial markers 204A-204K can be selected so that different orientations are distinguishable. Generally, any non-circular and/or non-symmetric shape can be chosen for the fiducial markers 204A-204K, so that at least one orientation of the fiducial markers 204A-204K is distinguishable from another orientation. However, indicators on the fiducial markers 204A-204K can also aid in distinguishing between different orientations. For example, each of the fiducial markers 204A-204K may have multiple different faces. Different indicators (such as different letters, numbers, symbols, etc.) can be placed on different faces of a given fiducial marker 204A-204K, such that the control system can distinguish between the faces when analyze the image data. The fiducial markers 204A-204K could also have different colors, and/or different faces on a given fiducial marker 204A-204K could have different colors, to aid in distinguishing between different fiducial markers 204A-204K, or between different faces of the same fiducial marker 204A-204K.

In some implementations, the fiducial markers 204A-204K are non-rotationally coupled to the body 202. In these implementations, if a portion of the body 202 and one or more of the fiducial markers 204A-204K naturally rotate when placed on the individual, each of the fiducial markers 204A-204K will also rotate. This allows the control system to identify the rotation of the fiducial markers 204A-204K, which can aid the control system in determining the positions of the fiducial markers 204A-204K (and therefore the trial implement 200) relative to the individual. However, in other implementations, each of the fiducial markers 204A-204K may be rotationally coupled to the body 202, such that no matter the orientation or position of the trial implement 200, each of the fiducial markers 204A-204K will generally maintain the same orientation due to gravity.

In some implementations, the body 202 is formed from a single continuous piece of material, and each of the fiducial markers 204A-204K can be coupled or attached to the body 202. For example, each of the fiducial markers 204A-204K can have at least one opening defined therethrough, such that the body 202 can be threaded through the fiducial markers 204A-204K. In this implementations (and other implementations), the trial implement 200 could include a latch 206 (illustrated in FIG. 2A) that is configured to attach the two ends of the body 202 together. In other implementations, the body 202 is formed as a loop that cannot be separated, and each of the fiducial markers 204A-204K is affixed to the loop that forms the body 202. The fiducial markers 204A-204K could be affixed to the body 202 in any suitable fashion, for example using hook-and-loop fasteners, adhesive, etc. In some implementations, the body 202 and/or the fiducial markers 204A-204K can be formed from a magnetic material. The fiducial markers 204A-204K can be magnetically coupled to a desired location along the body 202. In some implementations, the body 202 is continuously magnetic, so that the fiducial markers 204A-204K can be attached at any desired location. In other implementations, the body is substantially non-magnetic, but includes magnetic portions at desired locations for each of the fiducial markers 204A-204K. The fiducial markers 204A-204K can then be coupled to the magnetic portions of the body 202.

In some implementations, the fiducial markers 204A-204K are configured to transmit positional data to the control system 110. For example, each of the fiducial markers 204A-204K could include one or more sensors that are configured to generate the positional data, and one or more transmitters that are configured to transmit the positional data. The one or more sensors in each fiducial marker 204A-204K can include a global positioning system (GPS) module; an accelerometer; a gyroscope; a magnetometer; a barometric pressure sensor; a multiple degree of freedom sensor that combines multiple sensors (sometimes referred to as an inertial measurement unit (IMU) or an NDoF sensor (6DoF, 9DoF, 10DoF, etc.)); or any combination thereof.

In some implementations, the one or more sensors include a sensor configured to detect the location of a given fiducial marker 204A-204K relative to one or more other fiducial markers 204A-204K (such as the two adjacent fiducial markers 204A-204K along the body 202). The transmitter may be formed as a transceiver that is able to receive data from the control system 110 as well. The positional data generated by the fiducial markers 204A-204K in these implementations, can be indicative of the size of the body 202; the shape of the body 202; the orientation of the body 202; other characteristics of the body 202 or of the fiducial makers 204A-204K; or any combination thereof.

In some implementations, the trial implement 200 is modular. For example, the body 202 can be formed from smaller portions or segments that can be coupled together to form the full body 202 that will be worn by the individual. In some of these implementations, the fiducial markers 204A-204K are separate from the segments of the body 202, and can be individually attached to the segments. In other implementations, each segment of the body 202 includes at least one of the fiducial markers permanently or semi-permanently affixed thereto.

While FIG. 2A shows the trial implement 200 being formed as a single loop, other configurations can also be used. FIG. 2B shows trial implement portions 210 and 220 that can be added to the trial implement 200 to form a new configuration. Trial implement portion 210 is formed from a body 212 and a plurality of fiducial markers, including fiducial markers 214A and 214B. Trial implement portion 220 is formed from a body 222 and a plurality of fiducial markers, including fiducial markers 224A and 224B. The bodies 212 and 222 of the trial implement portions 210 and 220 can be the same as or similar to the body 202 of trial implement 200, and can have the same or similar properties. The fiducial markers of the trial implement portions 210 and 220 (including fiducial markers 214A, 214B, 224A, and 224B) can be the same as or similar to the fiducial markers 204A-204K of the trial implement 200, and can have the same or similar properties.

FIG. 2C shows a trial implement 201 with a non-standard configuration. Trial implement 201 includes the trial implement 200, and the trial implement portions 210 and 220. As can be seen, the trial implement 200 forms a main loop of trial implement 201. The trial implement portion 210 forms a lower intermediate loop that is shorter than the main loop, and the trial implement portion 220 forms an upper intermediate loop that is also shorter than the main loop. The trial implement portion 210 is positioned between the lower part of the main loop formed by the trial implement 200, and the upper intermediate loop formed by the trial implement portion 220. Each of the loops will generally be positioned about the neck of the individual when wearing the trial implement 201.

In some implementations, trial implement 201 is formed as a single integral trial implement. In other implementations, the trial implement 201 is modular, and is formed by coupling the trial implement portions 210 and 220 to the trial implement 200. In some of these implementations where the trial implement 201 is modular, the trial implement 200 and the trial implement portions 210 and 220 are integrally formed as their own separate pieces, and then are coupled together. In other implementations where the trial implement 201 is modular, the trial implement 200 and the trial implement portions 210 and 220 are formed from a plurality of individual body segments that are coupled together to form the desired shapes.

In either implementation, the trial implement portions 210 and 220 can be coupled to the trial implement 200 to form the non-standard configuration illustrated in FIG. 2C. In the illustrated implementation, the trial implement portion 210 is coupled to the trial implement 200 via body segment 212A and body segment 212B. The body segment 212A is coupled to the fiducial marker 214A of the trial implement portion 210, and also to fiducial marker 204C of the trial implement 200. Similarly, the body segment 212B is coupled to the fiducial marker 214B of the trial implement portion 210, and also to fiducial marker 204I of the trial implement 200. The fiducial markers 204C and 204I are also coupled to body segments 202A and 202B of the trial implement 200, respectively, and thus can be coupled to multiple body segments in order to couple the trial implement 200 and the trial implement portion 210.

The trial implement 200 and the trial implement portion 220 can be coupled in a similar fashion using body segments 222A and 222B of the trial implement portion 220. The body segment 222A is coupled to the fiducial marker 224A of the trial implement portion 220, and also to fiducial marker 204A of the trial implement 200. Similarly, the body segment 222B is coupled to the fiducial marker 224B of the trial implement portion 220, and also to fiducial marker 204K of the trial implement 200. The fiducial markers 204A and 204K are also coupled to body segments 202C and 202D of the trial implement 200, respectively, and thus can be coupled to multiple body segments in order to couple the trial implement 200 and the trial implement portion 220. Because the bodies of the trial implement portions 210 and 220 can be coupled to the trial implement 200 in this manner, the individual can easily obtain a trial implement in a desired shape, and can easily modify the trial implement that they are wearing, in order to show a virtual version of a different desired piece of jewelry using the electronic display device 140.

Generally, when the trial implement is modular, the trial implement may be formed in any desired configuration. In some implementations, the body is formed from a number of body segments, and each individual body segment can be coupled directly to one or more other body segments (e.g., two other body segments, three other body segments, etc.). This allows the body to be formed in a variety of different configurations, which could include configurations with different shapes, different sizes, etc. In some implementations, each body segment is configured to be coupled to at least one of the fiducial markers. In these implementations, none of the body segments are coupled directly to each other, but instead are arranged in the desired configuration by using the fiducial markers to link individual body segments. Each individual body segment could be configured to be coupled to a single fiducial marker, or multiple fiducial markers. Each individual fiducial marker could be configured to be coupled to a single body segment, or multiple body segments. In other implementations, each body segment can be coupled to one or more other body segments, and/or one or more fiducial markers. In some implementations, each body segment can be removably coupled to other body segments and/or fiducial markers. In other implementations, each body segment is generally permanently or semi-permanently affixed to at least one of the fiducial markers. Then, each body segment and its fiducial marker can then be removably coupled to other body segments and the fiducial markers of those other body segments.

The body segments and the fiducial markers could be coupled together using a variety of different techniques and mechanisms. In some implementations, the body segments and the fiducial markers are made from magnetic material, or have magnetic portions. The body segments and the fiducial markers could then be arranged in any suitable fashion. In other implementations, the body segments and the fiducial markers are made from non-magnetic material, but have magnetic portions that allow the body segments and the fiducial markers to be coupled together. For example, the body segments may have magnetic ends that can be attached to the magnetic ends of other body segments, and/or magnetic portions of fiducial markers.

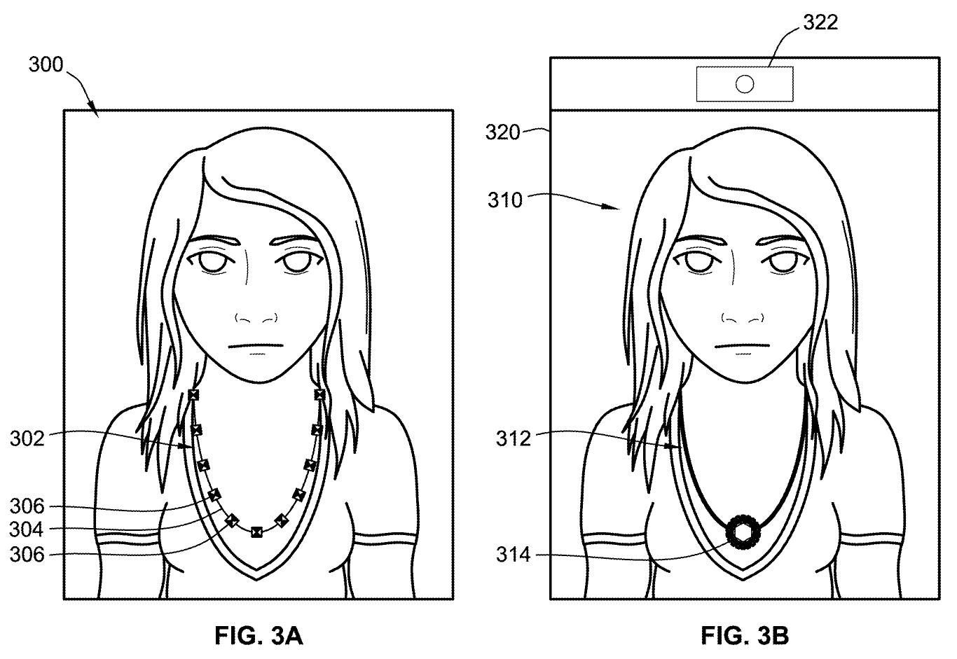

FIGS. 3A and 3B illustrate the system 100 of FIG. 1 displaying a virtual version of a piece of jewelry based on a trial implement. In FIG. 3A, an individual 300 wears a trial implement 302 around the individual 300′s neck. The trial implement 302 can be the same as or similar the trial implement 200 and the trial implement 201. As shown, the trial implement includes a body 304 and a plurality of fiducial markers 306. FIG. 3B shows an electronic display device 320 (which may be the same as or similar to the electronic display device 140) and a camera 322 (which may be the same as or similar to the image sensor 120) is positioned above the electronic display device 320. However, in other implementations, the camera 322 (or another type of image sensor or image sensors) may be located in different positions. The individual 300 is located within the field of view of the camera 322, which generates image data associated with the individual 300 and the trial implement 302. A control system (not shown) analyzes the image data, and causes the electronic display device 320 to display (i) a virtual version of the individual 300 (referred to herein as the virtual individual 310), and (ii) a virtual version of the desired piece of jewelry (referred to herein as the virtual implement 312).

The virtual implement 312 has generally the same shape as the trial implement 302. The position of the virtual implement 312 relative to the virtual individual 310 is the same as the position of the trial implement 302 relative to the individual 300. However, the virtual implement 312 has the same appearance as the desired piece of jewelry. For example, the virtual implement 312 does not have the same thin body as the trial implement 302, but instead is shown as having a thicker body typical of a necklace, such as a body made of gold or silver. Moreover, because the fiducial markers 306 of the trial implement 302 are generally used only for determining the position of the trial implement 302 relative to the individual 300, the virtual implement 312 does not have any fiducial markers. Finally, the electronic display device 320 displays the virtual implement 312 with a gemstone 314 that is not present in the trial implement 302. In the illustrated implementation, the gemstone 314 appears in the same position (relative to the virtual individual 310 and the rest of the virtual implement 312) as one of the fiducial markers 306 (relative to the individual 300 and the rest of the trial implement 302). However, in other implementations, the gemstone 314 (or any gemstone) on the virtual implement 312 can be shown in any desired location, and does not have to match the same location as one of the fiducial markers 306 of the trial implement 302.

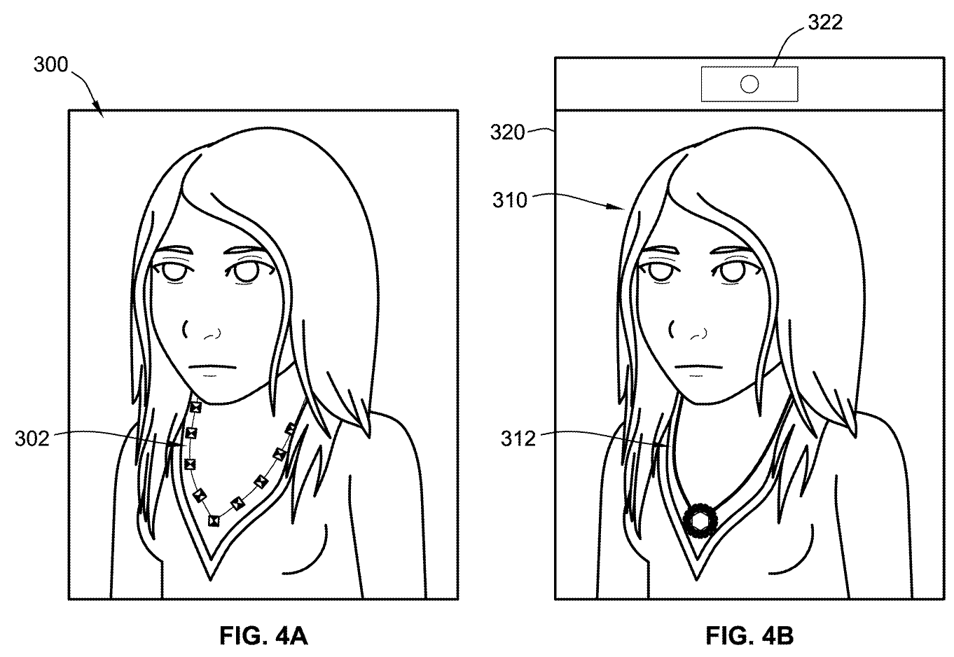

Referring now to FIGS. 4A and 4B, the electronic display device 320 can change the position of the virtual implement 312 to match the position of the trial implement 302. In FIG. 4A, the individual 300 has turned at an angle, such that the view of the trial implement 302 to the camera 322 has changed. In FIG. 4B, the electronic display device 320 shows the virtual individual 310 at an angle to match the individual 300. The virtual implement 312 is also shown at an angle, to match the position of the trial implement 302 that the camera 322 sees. By analyzing the image data generated by the camera 322, specifically to identify the trial implement 302 and/or the fiducial markers (and the positions thereof), the electronic display device 320 is able to display the virtual implement 312 in real-time as both the individual 300 and the trial implement 302 move.

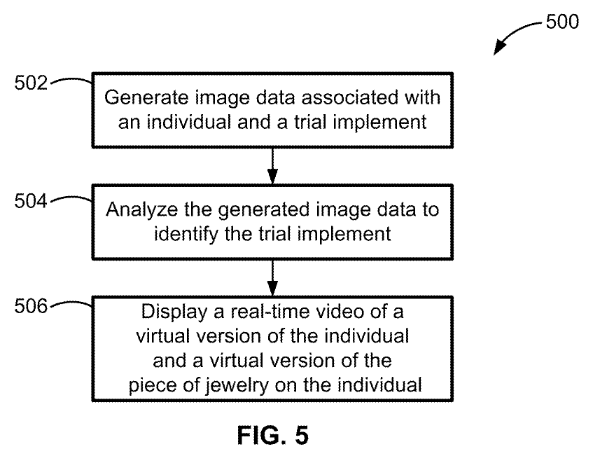

FIG. 5 shows a flowchart of a method 500 for permitting an individual (such as individual 300) to virtually try on a desired piece of jewelry using augmented reality. Method 500 can be implemented using any suitable control system and/or processing device, such as control system 110 of system 100. At step 502, image data associated with the individual and a trial implement is generated. The image data can be stored in any suitable memory device, such as memory device 130 of system 100. In some implementations, the image data is continually generated in real-time, for example when a real-time video will be displayed to the individual. However, in other implementations, the image data is generated only once, for example if a single still image is going to be displayed. The trial implement could be the same as or similar to any of trial implements 200, 201, or 302. In some implementations, the individual is wearing the trial implement (such as on the individual’s neck or wrist) when the image data is generated. The image data could be reproduced as still images, real-time videos, video clips, etc.

Generally, the shape of the trial implement is the same shape as the desired piece of jewelry. For example, if the desired piece of jewelry is a necklace, the trial implement will be shaped like a necklace, and will be worn about the individual’s neck, shoulders, and upper torso area. If the desired piece of jewelry is a bracelet, the trial implement will be shaped like a bracelet, and will be worn on the individual’s wrist. If the desired piece of jewelry is a watch, the trial implement will be shaped like a watch, and will be worn on the individual’s wrist. The trial implement could also be placed on the individual’s arm, ankle, torso, etc. Generally, the piece of jewelry could be any type of jewelry (e.g., a necklace, a wrist bracelet, an ankle bracelet, a watch, a ring, a belt, a tiara or other headpiece, an earring or other piercing, etc.), and the trial implement can be shaped like the piece of jewelry and worn by the individual in the same fashion as how the individual would wear the actual piece of jewelry.

At step 504 of method 500, the generated image data is analyzed to identify the trial implement. The image data can be analyzed by the control system. At step 506 of method 500, a real-time video is displayed. The real-time video will include a virtual version of the individual (referred to as the virtual individual) and a virtual version of the desired piece of jewelry (referred to herein as the virtual implement). In some implementations, identifying the trial implement includes determining the position of the trial implement in three-dimensional space, relative to a designated origin with the three-dimensional space. In some implementations, identifying the trial implement includes determining the real-time positional relationship between the individual and the trial implement. The real-time positional relationship between the virtual individual and the virtual implement that will be demonstrated in the real-time video can then be determined by the control system. In some implementations, the real-time positional relationship between the virtual individual and the virtual implement in the real-time video is identical to the real-time positional relationship between the individual and the trial implement. In other implementations, the real-time positional relationship between the virtual individual and the virtual implement in the real-time video is modified compared to the real-time positional relationship between the individual and the trial implement. Generally, when the electronic display device shows a real-time video of the virtual individual and the virtual implement, the position of the virtual implement relative to the virtual individual will be updated in real-time (or in near real-time).

In some implementations, analyzing the image data to identify the trial implement includes determining a number of different characteristics of the trial implement, such as the size of the trial implement, the shape of the trial implement, the circumference of the trial implement, the length of the trial implement, the orientation of the trial implement relative to some baseline (such as the individual), or any other characteristic or combination of characteristics.

In some implementations, identifying the trial implement includes identifying determining the location of one or more of the fiducial markers relative to the individual, determining the location of one or more of the fiducial markers relative to at least one other fiducial marker (such as one or more directly adjacent fiducial markers), determining the location of one or more of the fiducial markers relative to the body of the trial implement, or any combination thereof. In some implementations, identifying the trial implement includes determining the position of one or more of the fiducial markers in three-dimensional space, relative to a designated origin with the three-dimensional space. In some implementations, the fiducial markers can have different orientations that are distinguishable from each other (for example due to indicators on the fiducial markers, or the shape of the fiducial markers themselves). In these implementations, identifying the trial implement could also include determining the orientation of one or more of the fiducial markers.

Generally, the virtual implement in the real-time video that is shown on the electronic display device can be modified in any number of different ways. In some implementations, the virtual implement has a different color than the trial implement. For example, the trial implement may be formed primarily from a light-colored (and sometimes transparent or partially transparent) material. However, the virtual implement shown in the real-time video may have a different color, such as gold or silver. In some implementations, the virtual implement shown in the real-time video includes features not present on the trial implement, such as gemstones or other ornamental designs. In some implementations, the virtual model can be generated by modifying the image data associated with the trial implement. For example, a portion of the image data can be replaced with image data associated with the virtual implement. In these examples, the control system may already have access to image data associated with the virtual implement (e.g., the actual piece of jewelry that the individual wishes to try on), so that the control system can replace all or part of the trial implement image data with the virtual implement image data.

In some implementations, the analysis of the image data can be aided by a 3D model of the desired piece of jewelry. For example, if the individual wishes to virtually try on a particular necklace, a 3D model of that particular necklace could be stored in the memory device. Then, once the control system has identified the trial implement, the control system can either simply show the 3D model on the electronic display device as part of the real-time video, or use the 3D model to aid in generating the virtual implement to be shown on the electronic display device.

In some implementations, the memory device can receive and store an image data library that the control system can access to aid in identifying the trial implement and to aid in displaying the virtual implement in the real-time video. The image data library can include image data that is associated with a variety of different known trial implements. For example, the image data library may include image data associated with trial implements that represent a collar necklace, a choker necklace, a princess necklace, a matinee necklace, an opera necklace, a lariat necklace, and others. When the control system analyzes the image data associated with the individual and their trial implement, that image data can be compared to the image data library to aid the control system in identifying the trial implement, and in generating the virtual implement to be display in the real-time video.

In some implementations, analyzing the generated image data includes detecting the user’s face and any other upper body landmarks using 3D post estimation, and determining the position of the trial implement. Generally, the position of the trial implement (or of the one or more fiducial markers) will be determined across multiple moments in time, so that the trajectory of the trial implement is known. In some cases, the position of the trial implement can be defined by coordinates within two-dimensional space. In these cases, analyzing the image data to determine the trajectory of the trial implement includes continually determining the position of the trial implement using 2D coordinates. In other cases, the position of the trial implement is additionally or alternatively defined relative to the plane of the user’s skin. In these implementations, the position of the trial implement can be defined using one or more two-dimensional vectors in the local plane of the user’s skin. The trajectory of the trial implement is then determined by continually determining the position of the trial implement, using these two-dimensional vectors.

The coordinates of the user’s face and any upper body landmarks, as well as the coordinates defining the position and/or trajectory of the trial implement, can be input into a trained machine learning algorithm that outputs the position and/or trajectory of the virtual implement in the real-time video. The position and/or trajectory can be defined using a set of coordinates in 3D space, as well as a set of 3D vector coordinates in the plane of the user’s skin in the video. In some implementations, the machine learning algorithm is a neural network. The machine learning algorithm can be trained using the trial implement. When training the neural network, the desired location of the virtual implement in the video can be estimated, and used as the desired output of the neural network. The neural network is then trained using the input data associated with the trial implement. In some implementations, the training also includes having the person wearing the trial implement move around to different positions and/or orientations relative to the camera. In some implementations, the training also includes having multiple different people with multiple different body shapes wear the trial implement in front of the camera.

In some implementations, displaying the virtual implement in the video includes removing a virtual version of the trial implement from the video, e.g., replacing the portion of the image data reproducible as a virtual version of the trial implement with image data reproducible as the virtual implement. To do this, a variety of different inpainting techniques can be used.

While the trial implement is shown herein as being associated with a necklace, the trial implement can be associated with other types of jewelry as well. For example, in some implementations, the trial implement has the shape of a watch on the individual’s wrist. In some of these implementations, the fiducial markers of the trial implement can mark the boundary of the watch face. The control system can then generate a desired watch face for the virtual implement that is located within the boundary established by the fiducial markers. Thus, the watch face of the trial implement (which is generally just a blank area bounded by the fiducial markers, but could also be an actual watch face) can be shown in the virtual implement has a different watch face.

One or more elements or aspects or steps, or any portion(s) thereof, from one or more of any of claims 1-63 below can be combined with one or more elements or aspects or steps, or any portion(s) thereof, from one or more of any of the other claims 1-63 or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

1. A method of permitting an individual to virtually try on a piece of jewelry using augmented reality, the method comprising:
generating image data associated with the individual and a trial implement, the trial implement being positioned about a portion of the individual;
analyzing the image data to identify the trial implement; and
causing an electronic display device to display a real-time video of a virtual version of the individual and a virtual version of the piece of jewelry on the individual, the virtual version of the piece of jewelry being positioned relative to the virtual version of the individual based at least in part on the identified trial implement.

2. The method of claim 1, wherein identifying the trial implement includes determining a real-time positional relationship between the individual and the trial implement.

3. The method of claim 2, further comprising determining a real-time positional relationship in the real-time video between the virtual version of the individual and the virtual version of the piece of jewelry, based at least in part on the real-time positional relationship between the individual and the trial implement.

4. The method of claim 3, wherein the real-time positional relationship in the real-time video between the virtual version of the individual and the virtual version of the piece of jewelry is identical to the real-time positional relationship between the individual and the trial implement.

5. The method of claim 1, wherein a position of the virtual version of the piece of jewelry relative to the virtual version of the individual is updated in real-time in response to a position of the trial implement relative to the individual being changed.

6. The method of claim 1, further comprising, prior to the causing, receiving a three-dimensional digital model of the piece of jewelry that is displayable as the virtual version of the piece of jewelry.

7. The method of claim 1, wherein analyzing the video data includes determining a circumference of the trial implement, a length of the trial implement, a shape of the trial implement, an orientation of the trial implement relative to the individual, or any combination thereof.

8. The method of claim 1, wherein the trial implement includes a plurality of fiducial markers, and wherein analyzing the video data includes determining a location of the trial implement relative to the individual, a location of each of the plurality of fiducial markers relative to the individual; a location of each of the fiducial markers relative to at least one adjacent fiducial marker, an orientation of each of the plurality of fiducial markers, or any combination thereof.

9. The method of claim 8, wherein determining the location of the trial implement relative to the individual includes determining a location of the trial implement in a three-dimensional space.

10. The method of claim 8 , wherein determining the location of each of the plurality of fiducial markers relative to the individual includes determining a location of each of the plurality of fiducial markers in a three-dimensional space.

11-26. (canceled)

27. A system for permitting an individual to virtually try on a piece of jewelry using augmented reality, the system comprising:
an image sensor configured to generate image data;
an electronic display device configured to display real-time videos;
a memory device storing machine-readable instructions; and
a control system including one or more processors configured to execute the machine-readable instructions to:
cause the image sensor to generate image data associated with the individual and a trial implement, the trial implement being positioned about a portion of the individual;
analyze the image data to identify the trial implement; and
cause the electronic display device to display a real-time video of a virtual version of the individual and a virtual version of the piece of jewelry on the individual, the virtual version of the piece of jewelry being positioned relative to the virtual version of the individual based at least in part on the identified trial implement.

28. A trial jewelry implement for permitting an individual to virtually try on a piece of jewelry using augmented reality, the trial jewelry implement comprising:
a body configured to be positioned about a portion of the individual; and
a plurality of fiducial markers coupled to the body, each of the plurality of fiducial markers being located a known distance along the body away from at least one adjacent fiducial marker of the plurality of fiducial markers.

29. The trial jewelry implement of claim 28, wherein the body is formed from a flexible material.

30. The trial jewelry implement of claim 28 , wherein the body is formed from an optically non-reflective material.

31. The trial jewelry implement of claim 28, wherein the body is formed from metal.

32. The trial jewelry implement of claim 28, wherein each of the plurality of fiducial markers is formed from an optically reflective material.

33. The trial jewelry implement of claim 28, wherein each of the plurality of fiducial markers is non-rotationally coupled to the body.

34. The trial jewelry implement of claim 28, wherein the body is shaped like a necklace, and wherein the body is configured to be worn on a neck of the individual.

35. The trial jewelry implement of claim 28, wherein the body is shaped like a bracelet or a watch, and wherein the body is configured to be positioned about a wrist of the individual.

36. The trial jewelry implement of claim 35, wherein at least a portion of the plurality of fiducial markers form an outline of a watch face on the body.

37-63. (canceled)
